(19) United States
(12) Patent Application Publication
(10) Pub. No.: US 2025/0067399 A1
(43) Pub. Date: Feb. 27, 2025

(54) FUEL TANK WITH INTERNAL SPRINGS

(71) Applicant: Textron Innovations Inc., Providence, RI (US)

(72) Inventors: Joseph Dean Rainville, Fort Worth, TX (US); Phalgun Madhusudan, Malleshwaram (IN)

(73) Assignee: Textron Innovations Inc., Providence, RI (US)

(21) Appl. No.: 18/942,349

(22) Filed: Nov. 8, 2024

Related U.S. Application Data
(63) Continuation-in-part of application No. 17/690,097, filed on Mar. 9, 2022.

(30) Foreign Application Priority Data
Jan. 3, 2024 (IN) 202421000595

(51) Int. Cl. F17C 13/00; H01M 8/04082

(52) U.S. Cl. CPC F17C 13/002; H01M 8/04216; F17C 2201/056; F17C 2221/012

(57) ABSTRACT

A fuel tank has an outer shell, a media guide disposed within the space at least partially defined by the outer shell, the media guide being configured to receive a media within cells of the media guide. The fuel tank further has a spring space disposed between the media guide and the outer shell and a compressible spring disposed within the spring space and connected between the outer shell and the media guide.

### CROSS-REFERENCE TO RELATED APPLICATIONS

This patent application claims the benefit of the filing date of Indian patent application Ser. No. 202421000595, filed on 3 Jan. 2024 and titled “INTERNAL SPRINGS FITTED WITHING A FUEL TANK,” the entire content of which is hereby expressly incorporated by reference. This application is a continuation-in-part of U.S. patent application Ser. No. 17/690,097, filed on 9 Mar. 2022 by Joseph Dean Rainville, et al., and titled “INTERNALLY COMPLIANT FUEL TANK” the entire content of which is hereby expressly incorporated by reference.

### BACKGROUND

In many applications regarding providing power to electrically powered systems, providing high power density and providing lightweight sources of power are very important. For example, while batteries can provide high power density they are very heavy. In some cases, powering an electrically powered system using a fuel cell is beneficial over using batteries. However, even in systems utilizing fuel cell systems, the components used to enable operation of a fuel cell system also may need to be power dense and lightweight. One such component is a fuel tank for supplying hydrogen fuel to a fuel cell system. Conventional fuel tanks are very heavy, especially those utilized with expandable fuel media and there is a need for lighter fuel tanks that are used with expandable fuel media while still providing efficient heat transfer.

Fuel cells operate by allowing an electrochemical reaction between hydrogen and oxygen, which produces electrical energy and water. In most fuel cell powered vehicles, hydrogen fuel, stored in an onboard hydrogen fuel tank, is supplied to an anode of the fuel cell and ambient air is supplied to a cathode of the fuel cell. The electrical energy produced drives a motor and the water is disposed of. The hydrogen fuel tanks are often externally coupled to a vehicle

Conventional hydrogen fuel tanks can be very heavy and comprise thick walls that are used to withstand not only gaseous pressurization but also mechanical expansion forces of some fuel components, such as, but not limited to, solid state hydride within the hydrogen fuel tanks. Accordingly, there exists a need for a lighter fuel tank that is capable of efficient heat transfer.

### BRIEF DESCRIPTION OF THE DRAWINGS

FIG. 1 is a cross-sectional view of a fuel tank according to an embodiment of this disclosure.

FIG. 2 is a flowchart of a method of operating a fuel tank according to an embodiment of this disclosure.

FIG. 3 is partial cross-sectional view of a fuel tank comprising internal springs according to an embodiment of this disclosure.

FIG. 4 is another partial cross-sectional view of the fuel tank of FIG. 3 with the internal springs hidden from view.

### DETAILED DESCRIPTION

While the making and using of various embodiments of this disclosure are discussed in detail below, it should be appreciated that this disclosure provides many applicable inventive concepts, which can be embodied in a wide variety of specific contexts. The specific embodiments discussed herein are merely illustrative and do not limit the scope of this disclosure. In the interest of clarity, not all features of an actual implementation may be described in this disclosure. It will of course be appreciated that in the development of any such actual embodiment, numerous implementation-specific decisions must be made to achieve the developer's specific goals, such as compliance with system-related and business-related constraints, which will vary from one implementation to another.

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. In addition, the use of the term “coupled” throughout this disclosure may mean directly or indirectly connected, moreover, “coupled” may also mean permanently or removably connected, unless otherwise stated.

This disclosure divulges a vehicle comprising an internally compliant fuel tank. In the least, this disclosure enables a vehicle that is powered by a fuel cell that is provided fuel from an internally compliant fuel tank. This disclosure contemplates a variety of embodiments of an internally compliant fuel tank with some variations including geometry and composition of the internally compliant components. Moreover, the systems and methods disclosed herein can be used on any vehicle or device that stores or otherwise utilizes hydrogen fuels, such as, but not limited to fuels comprising solid state hydride.

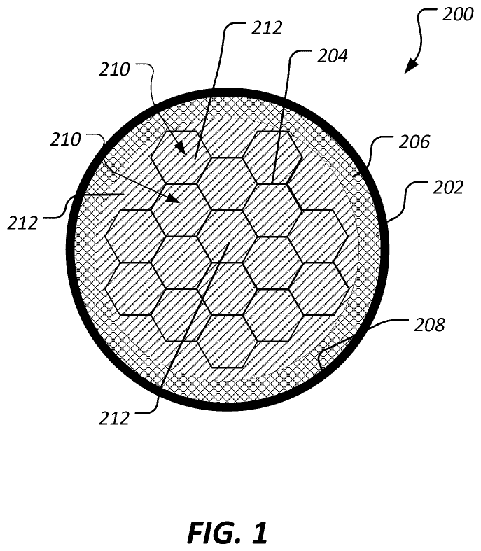

Referring now to FIG. 1, a cross-sectional view of a fuel tank 200 is shown. Most generally, fuel tank 200 comprises an exterior shell 202, an interior media guide 204, and a compliant layer 206 disposed adjacent an inner profile 208 of exterior wall 202. Exterior shell 202 can comprise metal, such as, but not limited to, steel or aluminum. Exterior shell 202 can generally be shaped as a cylinder having end caps with one of the end caps comprising a filling neck. Interior media guide 204 comprises a honeycomb-shaped profile that provides columnar segregation between adjacent cells 210 spaces defined by media guide 204. In some cases, compliant layer 206 can comprise one or more of metal aerogels, metallic foams, and/or honeycomb lattice structure. In some cases, space within fuel tank 200 that is located interior relative to the compliant layer 206, can be filled with media 212 such as, but not limited to, solid state hydride. In some cases, media 212 can comprise a power or granular form that can be poured into tank 200 both within cells 210 and into spaces between media guide 204 and compliant layer 206. In this embodiment, compliant layer 206 is substantially shaped as a cylindrical tube and is adhered to or lays adjacent inner profile 208. A length of compliant layer 206 is substantially similar to or longer than a length of media guide 204.

While compliant layer 206 can be a cylindrical tube, in alternative embodiments, a compliant layer can be formed in any other suitable shape, such as, but not limited to, conforming to any other inner profile of a fuel tank. For example, in alternative embodiments, a fuel tank can be shaped irregularly and/or as a component of a vehicle and the compliant layer can complement and/or follow the inner profile or a portion of the inner profile. In other embodiments, multiple compliant layers can be provided that are not continuous along an inner profile. For example, a series of cylindrical tubular shaped compliant layers can be offset from each other and/or joined by a portion of compliant layer that is of a different thickness. This disclosure contemplates fuel tanks having any suitable number, degree, shape, thickness, composition (whether homogeneous or not) of compliant layers. Accordingly, one or more embodiments disclosed herein can accommodate physical expansion and contraction of media, including expansion and contraction that is predictable, unpredictable, repeated, permanent, symmetric, unsymmetric, fast and/or slow and in any direction. The expansion and contraction are accommodated by the at least partially elastic deformation of the compliant layer.

In some embodiments, this disclosure divulges a thermally conductive, mechanically compliant cylinder liner that can significantly reduce cylinder wall stress on a hydride storage cylinder. In some cases, solid state hydrogen media can volumetrically expand at least about 19-22%. Using a conventional heavy commercial aluminum solid state hydrogen storage cylinder, the media expansion can raise cylinder loads to 2,200 psi. However, by adding a thermally conductive, compliant layer between the tank walls and the hydride material, a cylinder with about one fourth the strength and mass (i.e. a thinner outer wall relative to the outer wall of the conventional tank) can be used to contain the hydride and the about 500 psi of hydrogen gas pressure. In some cases, the thinner wall can comprise a radius of about 10% greater relative to the conventional tank, but nonetheless still provide a mass savings of about 50-60%. This mass savings can translate to increased range, speed, and/or maneuverability of a vehicle. It is important to note that the hydride media disclosed herein can be recharged with hydrogen to increase hydrogen content after hydrogen depletion. Most generally, heat transfer rates can be a limiting factor on recharging hydride media. Accordingly, it is important that the compliant layer be an efficient conductor of heat.

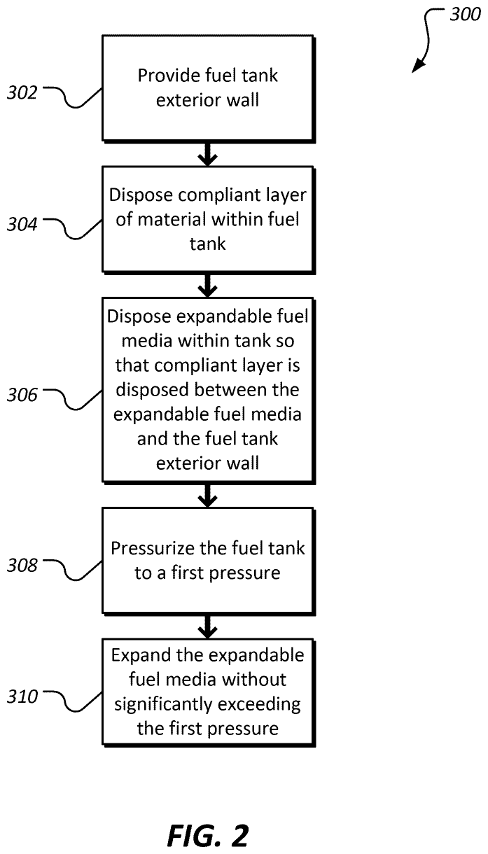

Referring now to FIG. 2, a flowchart of a method 300 of operating a fuel tank is shown. Method 300 can begin at block 302 by providing a substantially rigid fuel tank exterior wall. Next at block 304, the method 300 can progress by disposing a compliant layer of material within the fuel tank. At block 306, expandable fuel media can be disposed within the fuel tank so that the compliant layer is disposed between the expandable fuel media and the fuel tank exterior wall. Next at block 308, the fuel tank can be pressurized to accommodate a gas pressure. Finally, at block 310 the method 300 can continue by expanding the expandable fuel media without significantly exceeding the first pressure. It will be appreciated that the expansion of the fuel media is accommodated by the at least partially elastic deformation of the compliant layer.

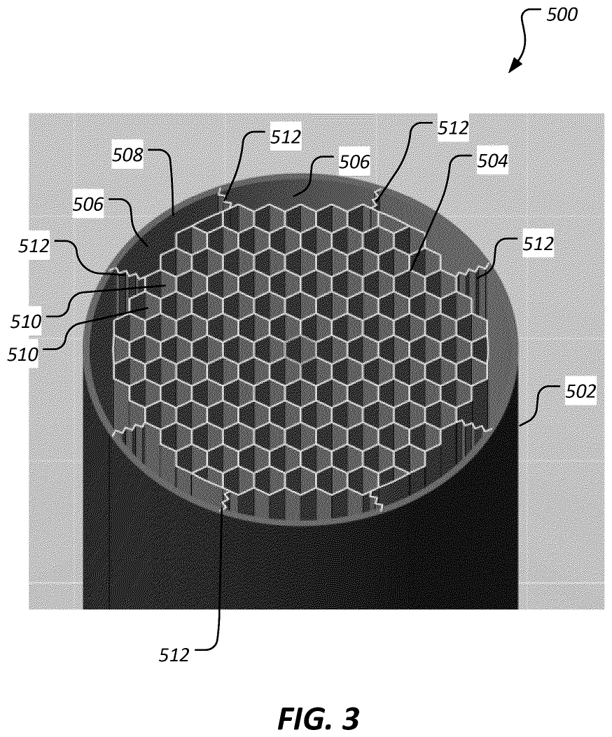

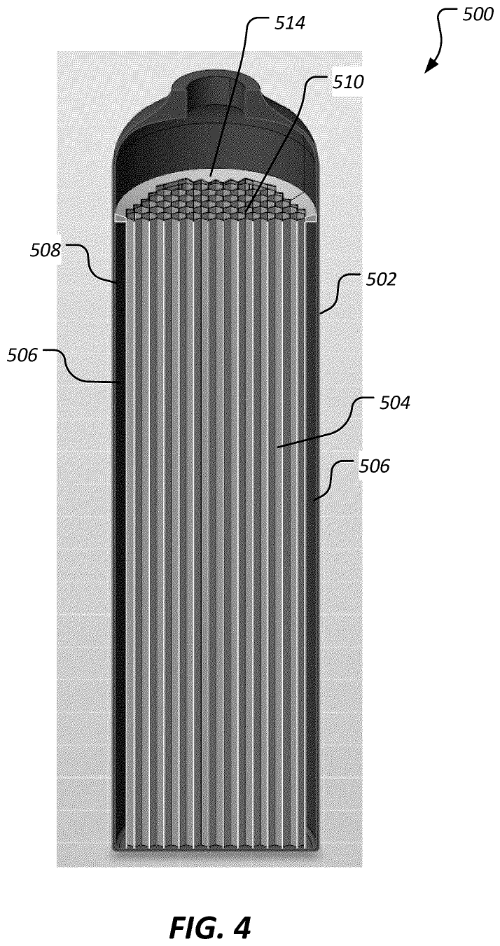

Referring now to FIGS. 3 and 4, a fuel tank 500 according to another embodiment of this disclosure is shown. Most generally, fuel tank 500 comprises an exterior shell 502, an interior media guide 504, and a spring space 506 disposed adjacent an inner profile 508 of exterior wall 502. Exterior shell 502 can comprise metal, such as, but not limited to, steel or aluminum. Exterior shell 502 can generally be shaped as a cylinder having end caps with one of the end caps comprising a filling neck. Interior media guide 504 comprises a honeycomb-shaped profile that provides columnar segregation between adjacent cells 510 spaces defined by media guide 504. Cells 510 can be filled with media such as, but not limited to, solid state hydride, however, media is not provided in the spring space 506. Instead, spring space 506 is generally free space for accommodating radial springs 512. In this embodiment, radial springs 512 comprise a generally corrugated profile when viewed from above and are configured to allow radial expansion of the interior media guide 504. In this embodiment, springs 512 are rigidly attached to the interior media guide 504 and the inner profile 508 of exterior shell 502. In alternative embodiments, one or more of the interior media guide 504, springs 512, and shell 502 can be formed integrally or three dimensionally printed.

In this embodiment, eight springs 512 extend longitudinally substantially the entire length of the media guide 504 and are disposed about a central axis of the fuel tank 500 in an angular array as viewed from above. However, in alternative embodiments, greater or fewer than eight springs 512 can be disposed in the spring space 506. Further, in alternative embodiments, one or more of the springs 512 can be shorter than the entire length of the media guide 504, disposed at different angular locations, and/or exist longitudinally above or below other springs 512. A length of compliant layer 206 is substantially similar to or longer than a length of media guide 204.

In this embodiment, the fuel tank 500 further comprises a cover 514 for preventing media from entering the spring space 506 from above and the media guide is rigidly attached to the base of the fuel tank, thereby substantially sealing the spring space 506.

In yet other embodiments, springs 512 can be replaced by disposing one or more of metal aerogels, metallic foams, and other three dimensional structures configured for selective radial compression in response to expansion of the media guide 504.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

what is claimed is:

1. A fuel tank, comprising:
an outer shell;
a media guide disposed within the space at least partially defined by the outer shell, the media guide being configured to receive a media within cells of the media guide;
a spring space disposed between the media guide and the outer shell; and
a compressible spring disposed within the spring space and connected between the outer shell and the media guide.

2. The fuel tank of claim 1, wherein the outer shell is cylindrical and the spring is compressible in a radial direction relative to the outer shell.

3. The fuel tank of claim 1, wherein the spring space is free of media to allow for movement of the spring.

4. The fuel tank of claim 1, wherein a plurality of springs are disposed in an angular array when viewed from above.

5. The fuel tank of claim 1, wherein media guide comprises a honeycomb shape when viewed from above.

6. The fuel tank of claim 1, further comprising:
a cover disposed above the spring space and configured to prevent media from entering the spring space.

7. The fuel tank of claim, wherein the spring comprises a corrugated shape.

8. The fuel tank of claim 1, wherein the spring comprises at least one of metal aerogels, metallic foams, and/or a three dimensionally printed radially compliant structure.

9. A method of operating a fuel tank system, comprising:
providing a fuel tank comprising an outer shell;
disposing a media guide within the space at least partially defined by the outer shell;
providing a spring space between the outer shell and the media guide; and
disposing a spring within the spring space.

10. The method of claim 9, further comprising:
disposing a cap within the fuel tank and above the spring space.

11. The method of claim 10, further comprising:
pouring media into the media guide while the cap prevents media from entering the spring space.

12. The method of claim 11, further comprising:
radially expanding the media guide; and
compressing the spring between the media guide and the outer shell.

13. The method of claim 9, further comprising:
rigidly attaching the media guide to a base of the fuel tank.

14. The method of claim 9, wherein the spring comprises a corrugated shape when viewed from above.

15. The method of claim 9, wherein the media guide comprises a honeycomb shape when viewed from above.

16. The method of claim 9, wherein the spring and the outer shell are integrally formed.

17. The method of claim 9, wherein the spring comprises at least one of metal aerogels, metallic foams, and/or a three dimensionally printed radially compliant structure [symbol]
